(19) United States
(12) Patent Application Publication
(10) Pub. No.: US 2017/0049038 A1
(43) Pub. Date: Feb. 23, 2017

(54) FARM IMPLEMENT FOR TILLING SOIL

(71) Applicant: UNVERFERTH MANUFACTURING COMPANY, INC., Kalida, OH (US)

(72) Inventors: Michael J. Hilvers, Fort Jennings, OH (US); David R. SMITH, Fort Jennings, OH (US); Thomas STEFFAN, Cloverdale, OH (US); Shawn W. GERDEMAN, Delphos, OH (US)

(73) Assignee: UNVERFERTH MANUFACTURING COMPANY, INC., Kalida, OH (US)

(21) Appl. No.: 15/239,536

(22) Filed: Aug. 17, 2016

Related U.S. Application Data
(60) Provisional application No. 62/207,536, filed on Aug. 20, 2015.

(51) Int. Cl. A01B 49/02; A01B 59/04

(52) U.S. Cl. CPC A01B 49/027; A01B 59/04

(57) ABSTRACT

A farm implement for tilling soil includes a frame having a transverse axis. The farm implement further includes at least one first ground engaging tool coupled to the frame and having a first tool axis oriented within a range of from parallel to the transverse axis to about 30 degrees of the transverse axis and at least one first finishing tool coupled to the frame adjacent to the first ground engaging tool, and having an axis generally aligned with or substantially parallel to the first tool axis. The at least one first finishing tool is configured to control a ground working depth of the at least one first ground engaging tool.

### CROSS-REFERENCE TO RELATED APPLICATIONS

This application claims priority to U.S. Provisional Patent Application Ser. No. 62/207,536, filed on Aug. 20, 2015, the disclosure of which is incorporated herein by reference in its entirety.

### BACKGROUND OF THE INVENTION

Field of the Invention

The present invention is related generally to a farm implement for tilling soil, and, more particularly, to a farm implement for tilling soil that uses a finishing tool for depth control.

Description of the Related Art

Farm implements for tilling soil are known in the art. Such implements typically include both ground engaging tools to dig into the soil and finishing tools to further manage the soil. It is necessary to control the depth of the ground engaging tools for effective tilling. Typical farm implements for tilling control depth by means of two or three depth control points which are not in close proximity to the ground engaging tool. Typically these depth control points are tires. One disadvantage of using tires as depth control points is that they compact the soil and leave tire tracks, which is not ideal for a seedbed.

A popular method of depth control is to control the depth of a front of the farm implement by either using gage wheels which are from three feet to five feet in front of the ground engaging tool or using the tow hitch on the farm implement which typically is from seven feet to twelve feet from the ground engaging tool. The rear depth is controlled by the lift wheels of the farm implement which are typically located from three feet to six feet away from the ground engaging tool.

In rolling ground or fields with swales, the known methods of depth control result in the ground engaging tool coming out of the ground when going across a valley and cutting deeper than desired on a ridge. One way of compensating for this uneven depth control in rolling ground or fields with swales is to place the ground engaging tools very close together with the lift wheels behind them. Doing this, however, because of the short nature of the design, results in farm implements that have a porpoising or see-saw effect going through the field, thus making an uneven seedbed depth.

Further, known farm implements for tilling typically have a maximum of two finishing tools (e.g. a treader, a rolling packer, or a rolling basket). As a result of this limitation, many known farm implements for tilling tow a second implement such as a rolling basket to resize the soil particles to get the desired soil size for an ideal seedbed. This results in a very long train of implements, which is not desirable.

### SUMMARY OF THE INVENTION

In accordance with a first aspect of the present invention, a farm implement for tilling soil includes a frame having a transverse axis. The farm implement further includes at least one first ground engaging tool coupled to the frame and having a first tool axis oriented within a range of from parallel to the transverse axis to about 30 degrees of the transverse axis and at least one first finishing tool coupled to the frame adjacent to the first ground engaging tool, and having an axis generally aligned with or substantially parallel to the first tool axis. The at least one first finishing tool is configured to control a ground working depth of the at least one first ground engaging tool.

In some embodiments, the farm implement further includes a second ground engaging tool coupled to the frame and having a second tool axis oriented within a range of from parallel to the transverse axis to about 30 degrees of the transverse axis and a second finishing tool coupled to the frame adjacent to the second ground engaging tool, and having an axis generally aligned with or substantially parallel to the second tool axis. The second finishing tool is configured to control a ground working depth of the second ground engaging tool.

In some embodiments, the farm implement further includes a third finishing tool coupled to the frame and oriented within a range of from parallel to the transverse axis to about 30 degrees of the transverse axis and a fourth finishing tool coupled to the frame and oriented within a range of from parallel to the transverse axis to about 30 degrees of the transverse axis.

In some embodiments, at least one of the first ground engaging tool and the second ground engaging tool includes disc blades configured to till soil. In some embodiments, at least one of the first finishing tool and the second finishing tool includes a rolling basket and/or a cylindrical rolling harrow.

In some embodiments, at least one of a distance between the first ground engaging tool and the first finishing tool and a distance between the second ground engaging tool and the second finishing tool is a distance of from one foot to three feet. In some embodiments, an angle of the disc blades of at least one of the first ground engaging tool and the second ground engaging tool is adjustable with respect to a direction of travel.

In some embodiments, the farm implement further includes a tow hitch coupled to the frame and a plurality of wheels coupled to the frame. In some embodiments, the at least one first finishing tool is adapted to carry substantially all of the residual weight of the farm implement not carried by the at least one ground engaging tool and a tow hitch connected to a towing equipment.

In accordance with a second aspect of the present invention, a method of tilling soil includes providing a farm implement. The farm implement includes a frame having a transverse axis; at least one first ground engaging tool coupled to the frame and having a first tool axis oriented within a range of from parallel to the transverse axis to about 30 degrees of the transverse axis; and at least one first finishing tool coupled to the frame adjacent to the first ground engaging tool, and having an axis generally aligned with or substantially parallel to the first tool axis. The at least one first finishing tool is configured to control a ground working depth of the at least one first ground engaging tool. The method further includes using the first finishing tool to control the ground working depth of the first ground engaging tool.

In some embodiments, the farm implement further includes a second ground engaging tool coupled to the frame and having a second tool axis oriented within a range of from parallel to the transverse axis to about 30 degrees of the transverse axis; and a second finishing tool coupled to the frame adjacent to the second ground engaging tool, and having an axis generally aligned with or substantially parallel to the second tool axis. The second finishing tool is configured to control a ground working depth of the second ground engaging tool. In these embodiments, the method further includes using the second finishing tool to control the ground working depth of the second ground engaging tool.

In some embodiments, the at least one first finishing tool is adapted to carry substantially all of the residual weight of the farm implement not carried by the at least one ground engaging tool and a tow hitch connected to a towing equipment. In these embodiments, when the farm implement is in operation, substantially no weight of the farm implement is carried by any wheels or tires of the farm implement.

### BRIEF DESCRIPTION OF THE DRAWINGS

FIG. 1 is a side view of a farm implement according to an exemplary embodiment of the present invention.

FIG. 2 is a perspective view of a farm implement according to an exemplary embodiment of the present invention.

FIG. 3 is a top view of a farm implement according to an exemplary embodiment of the present invention.

FIG. 4 is a top view of a farm implement according to an exemplary embodiment of the present invention.

FIG. 5 is a top view of a farm implement according to an exemplary embodiment of the present invention.

### DETAILED DESCRIPTION OF THE PRESENT INVENTION

While the present invention may be embodied in many different forms, a number of illustrative embodiments are described herein with the understanding that the present disclosure is to be considered as providing examples and not intended to limit the invention to the embodiments described and/or illustrated herein.

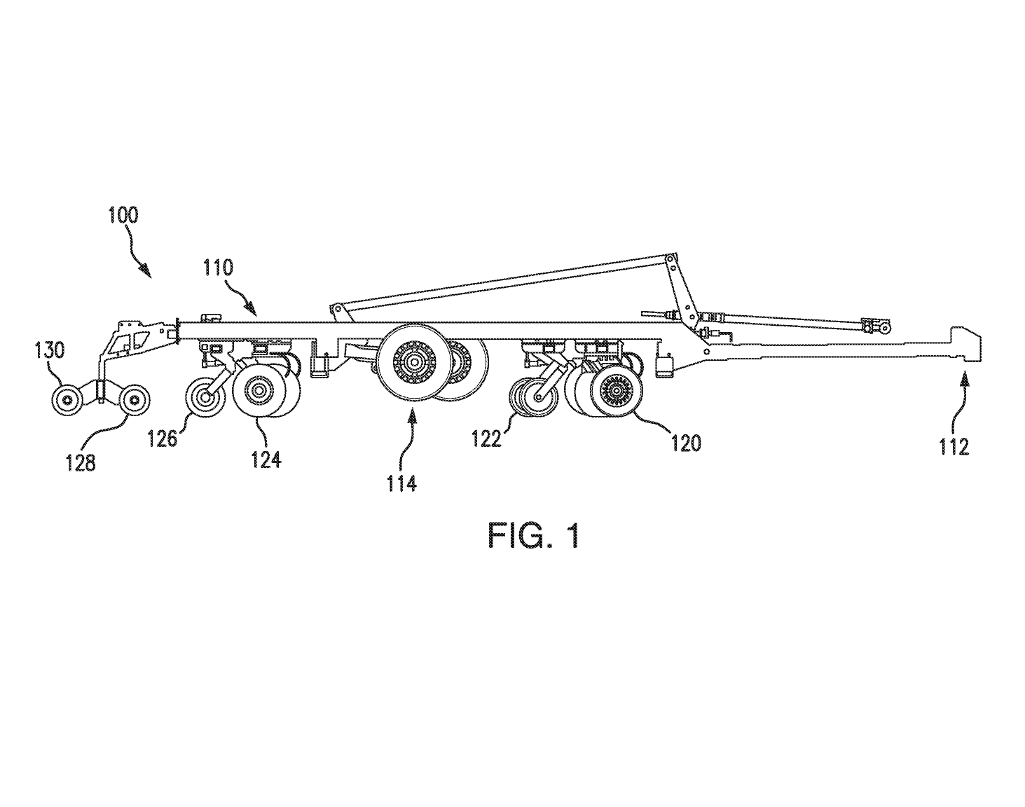

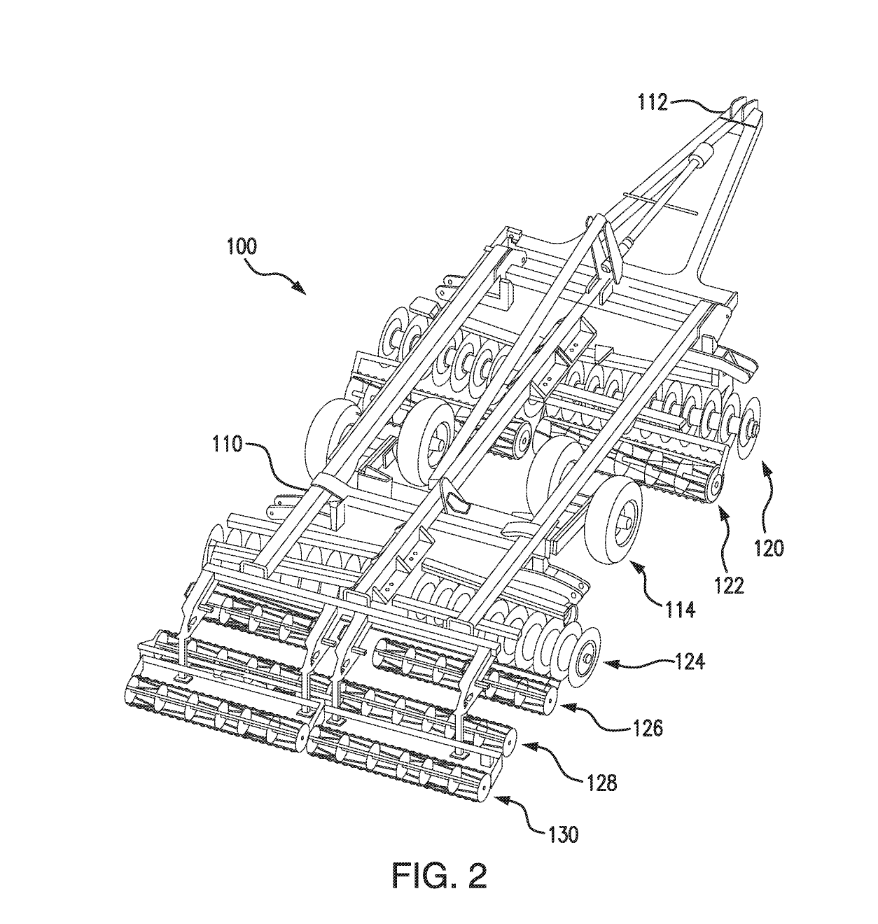

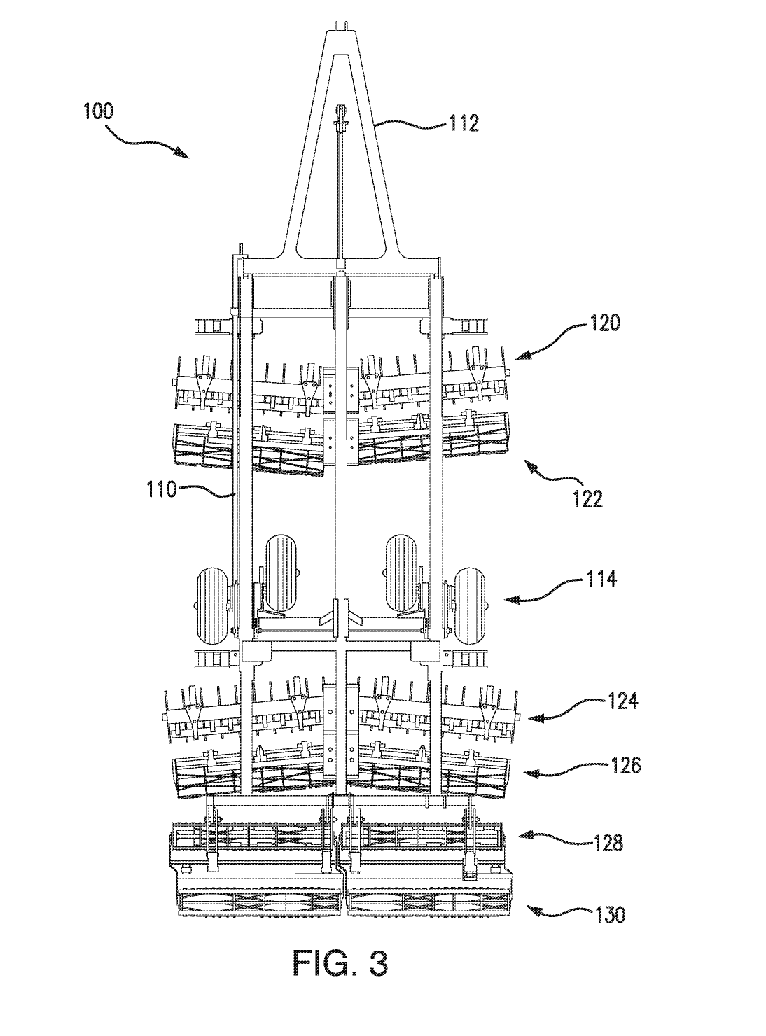

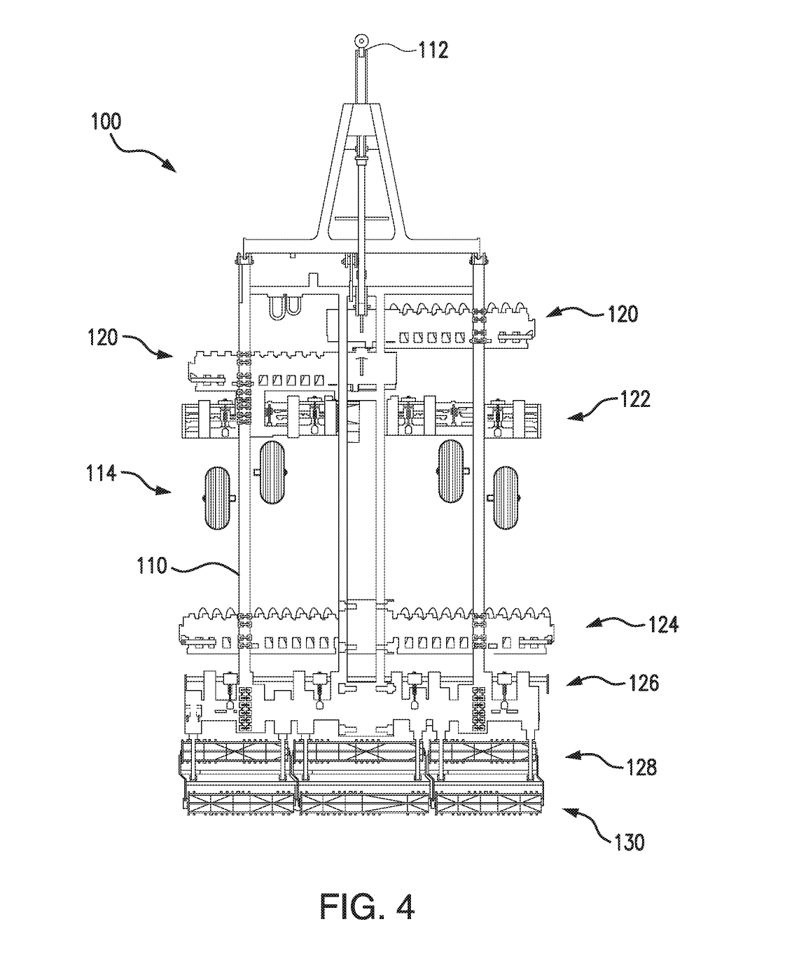

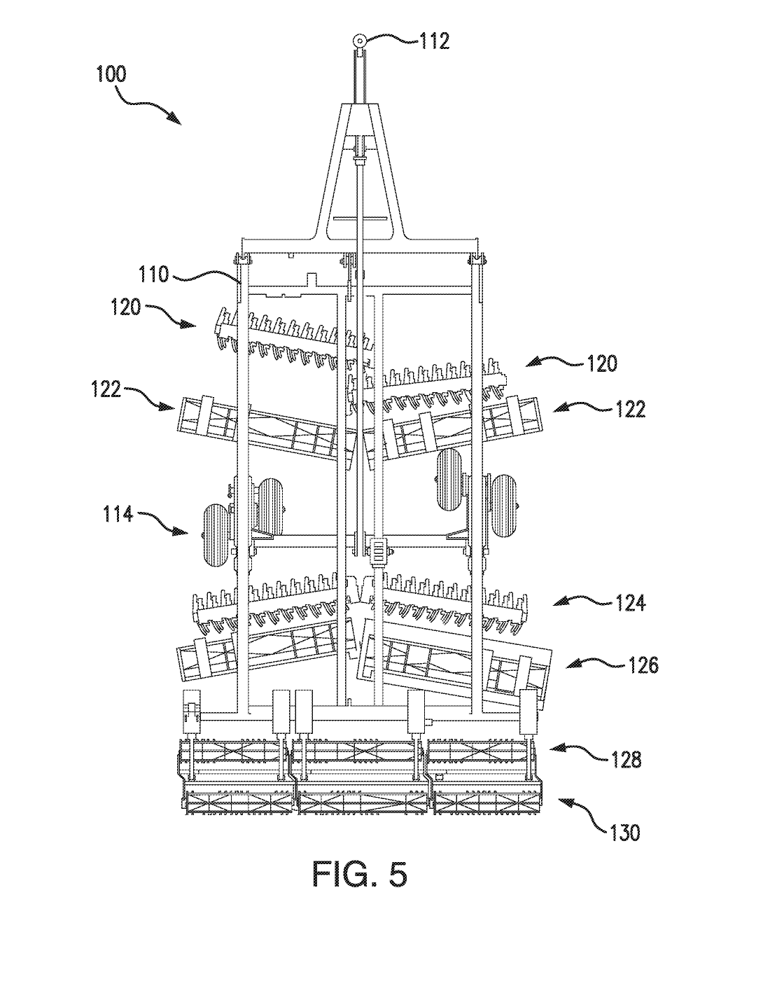

FIGS. 1-5 illustrate a farm implement 100 for tilling. The farm implement 100 is shown as having a frame 110, a tow hitch 112, transport wheels 114, and rows of ground engaging tools 120, 124 and rows of finishing tools 122, 126, 128, 130. The ground engaging tools 120, 124 are depicted as disc blades, which are used to till the soil, but could be any type of ground engaging tools such as discs or shovel points or a combination thereof The embodiment shown in FIGS. 1-5 depicts a first ground engaging tool 120 and a second ground engaging tool 124, but those skilled in the art will appreciate that there could be more or fewer rows of ground engaging tools. The finishing tools 122, 126, 128, 130 are depicted as cylindrical rolling baskets, but the finishing tools 122, 126, 128, 130 could be of any shape or surface that can roll and could be rolling baskets, rolling packers, treaders, or any other type of finishing tool or combinations thereof. The embodiment shown in FIGS. 1-5 depicts a first finishing tool 122, a second finishing tool 126, a third finishing tool 128, and a fourth finishing tool 130, but those skilled in the art will appreciate that there could be more or fewer rows of finishing tools.

The ground engaging tools 120, 124 are adjacent to the finishing tools 122, 126. In one embodiment, the first ground engaging tool 120 is from one foot to three feet away from the first finishing tool 122, for example about two feet away; and the second ground engaging tool 124 is from one foot to three feet away from the second finishing tool 126, for example about two feet away. The finishing tools 122, 126 serve the additional function of controlling the depth of the ground engaging tools 120, 124. By using depth control points that are in close proximity to the ground engaging tools, the depth is controlled more effectively that in known farm implements for tilling. For example, when the farm implement 100 for tilling is used in rolling ground or fields with swales, the use of depth control points in close proximity to the ground engaging tools keeps the ground engaging tools in the soil rather than coming out of the ground when going across a valley and cutting deeper than desired on a ridge. Further, using the finishing tools 122, 126 for ground working depth control eliminates the compacting effect that known depth control points such as tires can cause, because the finishing tools 122, 126 can cover the full width of the farm implement and thus increase the surface area contacting the ground proportionally, making the compaction minimal.

In accordance with some embodiments, the finishing tools may control the depth of the ground engaging tools by a depth of from about one inch to about ten inches.

With the finishing tools 122, 126 in close proximity to the ground engaging tools 120, 124, allows dirt and residue to be directed into the finishing tools 122, 126 as the farm implement 100 is tilling soil, which will churn and facture the soil into smaller particles making a desirable texture to the soil for optimum planting of crops. Under certain conditions, the finishing tools 122, 126 are “turbocharged” with the soil coming off the blades, i.e., soil is thrown off the blades onto the finishing tools and then applied to the ground by the finishing tools. The finishing tools 122, 126 thus can function for both ground working depth control and as a tillage tool.

The at least one finishing tool (or plurality of finishing tools) can be adapted to carry substantially all of the residual weight of the farm implement not carried by the at least one ground engaging tool (or plurality of ground engaging tools) and any tow hitch connected to a tractor or other equipment. According to this embodiment, in operation, substantially no weight of the farm implement is carried by transport wheels 114 or tires associated with such transport wheels 114. Instead, substantially all of the residual weight of the farm implement is carried by the at least one finishing tool (or plurality of finishing tools).

When a plurality of the ground engaging tools 120, 124 are utilized, increasing their distance from each other facilitates stability of the farm implement 100, which can provide more consistent tillage depth for an improved seedbed.

In some embodiments, the ground engaging tools and the finishing tools may have an axis that is oriented within a range of from parallel to the transverse axis of the farm implement to about 30 degrees of the transverse axis of the farm implement. In some embodiments, the finishing tools may be parallel or substantially parallel to the axis of the ground engaging tools to which they are adjacent. In some embodiments, each of the ground engaging tools and finishing tools have different orientations, in some embodiments they have the same orientations, and in some embodiments adjacent pairs of ground engaging tools and finishing tools may have the same or substantially the same orientation.

In some embodiments, the angle of the disc blades comprising the ground engaging tools 122, 126 can be adjusted with respect to the direction of travel to increase or decrease the amount of lateral soil movement. For example, a ground engaging tool may comprise a number of gang tubes, where disc blades having concave blades can be mounted to a gang tube at a concave angle to the direction of travel. In some embodiments, the disc blades are rigidly mounted to a gang tube. In some embodiments, different gang tubes within a row may be angled differently. In some embodiments, the rolling baskets comprising the finishing tools 122, 126, 128, 130 can also be angled or kept parallel to the gang tubes. This feature can enhance the ability to supercharge the rolling baskets with the soil coming off the disc blades for maximum agitation. For example, some or all of the finishing tools 122, 126, 128, 130 may, in accordance with some embodiments, be oriented within a range of from parallel to the transverse axis to about 30 degrees of the transverse axis.

In some embodiments, the disc blades on the gang tubes are from about one foot to about three feet in diameter, for example about 22 inches in diameter. In some embodiments, the disc blades on the gang tubes are about from about 1 foot to about 3 feet in diameter, and in some embodiments are about 24 inches in diameter. For example, the concave disc blades can be about 24 inches in diameter. In some embodiments, the diameter of the finishing tools 122, 126, 128, 130 are from about half a foot to about two feet, for example about 12 inches or about 16 inches. In some embodiments, the diameter of the depth control finishing tools 122, 126 are about 16 inches and the diameter of the rear following finishing tools 128, 130 are about 12 inches. In some embodiments, the depth control finishing tools 122, 126 apply from about 1000 lbs per row to about 11,000 lbs per row and in some embodiments apply from about 2000 lbs per row to about 4000 lbs per row, for example about 3500 lbs per row or from about 50 lbs per foot to about 270 lbs per foot, for example about 220 lbs per foot. In some embodiments, the working width of the finishing tools can be from about 15 feet to about 40 feet. In some embodiments, during operation of the farm implement 100 for tilling, the approximate height difference between the bottom of the depth control finishing tools 122, 126 and the bottom of the ground engaging tools 120, 124 is from about one inch to about five inches, which can be adjustable. Increasing the down pressure forces the finishing tools down and thus forces the machine up, thereby making a shallower working depth. One skilled in the art will appreciate that other dimensions can be used, and different combinations of dimensions for different rows of finishing or ground tools are possible.

The use of two, three, four, or more rows of finishing tools 122, 126, 128, 130 greatly improves the final soil particle size and minimizes the number of trips across a field when tilling.

The farm implement 100 may be towed via tow hitch 112 by a tractor or other equipment.

From the above it will be appreciated that the farm implement for tilling of the present invention provides for improved ground working depth control, reduces unwanted compaction, magnifies the effects of the finishing tool, and minimizes the number of trips across a field. It will also be appreciated that various changes can be made to the system without departing from the spirit and scope of the appended claims. For example, the farm implement may be propelled by tracks or treads instead of wheels. In another example, the farm implement may be self-propelled by motors rather than towed. In a further example, the motors can be gas, electric or hydraulic drive motors, or some combination of the foregoing types of drive motors. In another example, the farm implement can be used to till a variety of different field types, including flat, hilly, rocky, or rolling fields or fields with swales, etc. These and other modifications are intended to be encompassed within the scope of the appended claims.

We claim:

1. A farm implement for tilling soil comprising:
a frame having a transverse axis;
at least one first ground engaging tool coupled to the frame and having a first tool axis oriented within a range of from parallel to the transverse axis to about 30 degrees of the transverse axis; and
at least one first finishing tool coupled to the frame adjacent to the first ground engaging tool, and having an axis generally aligned with or substantially parallel to the first tool axis,
wherein the at least one first finishing tool is configured to control a ground working depth of the at least one first ground engaging tool.

2. The farm implement of claim 1, further comprising:
a second ground engaging tool coupled to the frame and having a second tool axis oriented within a range of from parallel to the transverse axis to about 30 degrees of the transverse axis; and
a second finishing tool coupled to the frame adjacent to the second ground engaging tool, and having an axis generally aligned with or substantially parallel to the second tool axis,
wherein the second finishing tool is configured to control a ground working depth of the second ground engaging tool.

3. The farm implement of claim 2, further comprising:
a third finishing tool coupled to the frame and oriented within a range of from parallel to the transverse axis to about 30 degrees of the transverse axis; and
a fourth finishing tool coupled to the frame and oriented within a range of from parallel to the transverse axis to about 30 degrees of the transverse axis.

4. The farm implement of claim 2, wherein at least one of the first ground engaging tool and the second ground engaging tool comprises disc blades configured to till soil.

5. The farm implement of claim 2, wherein at least one of the first finishing tool and the second finishing tool comprises a rolling basket.

6. The farm implement of claim 2, wherein at least one of the first finishing tool and the second finishing tool comprises a cylindrical rolling harrow.

7. The farm implement of claim 2, wherein at least one of a distance between the first ground engaging tool and the first finishing tool and a distance between the second ground engaging tool and the second finishing tool is a distance of from one foot to three feet.

8. The farm implement of claim 4, wherein an angle of the disc blades of at least one of the first ground engaging tool and the second ground engaging tool is adjustable with respect to a direction of travel.

9. The farm implement of claim 1, further comprising:
a tow hitch coupled to the frame; and
a plurality of wheels coupled to the frame.

10. A method of tilling soil, the method comprising:
providing a farm implement, said farm implement comprising:
a frame having a transverse axis;
at least one first ground engaging tool coupled to the frame and having a first tool axis oriented within a range of from parallel to the transverse axis to about 30 degrees of the transverse axis; and
at least one first finishing tool coupled to the frame adjacent to the first ground engaging tool, and having an axis generally aligned with or substantially parallel to the first tool axis,
wherein the at least one first finishing tool is configured to control a ground working depth of the at least one first ground engaging tool; and
using the first finishing tool to control the ground working depth of the first ground engaging tool.

11. The method of claim 10, wherein the farm implement further comprises:
a second ground engaging tool coupled to the frame and having a second tool axis oriented within a range of from parallel to the transverse axis to about 30 degrees of the transverse axis; and
a second finishing tool coupled to the frame adjacent to the second ground engaging tool, and having an axis generally aligned with or substantially parallel to the second tool axis,
wherein the second finishing tool is configured to control a ground working depth of the second ground engaging tool; and
wherein the method further comprises using the second finishing tool to control the ground working depth of the second ground engaging tool.

12. The method of claim 11, wherein the farm implement further comprises:
a third finishing tool coupled to the frame and oriented within a range of from parallel to the transverse axis to about 30 degrees of the transverse axis; and
a fourth finishing tool coupled to the frame and oriented within a range of from parallel to the transverse axis to about 30 degrees of the transverse axis.

13. The method of claim 11, wherein at least one of the first ground engaging tool and the second ground engaging tool comprises disc blades configured to till soil.

14. The method of claim 11, wherein at least one of the first finishing tool and the second finishing tool comprises a rolling basket.

15. The method of claim 11, wherein at least one of the first finishing tool and the second finishing tool comprises a cylindrical rolling harrow.

16. The method of claim 11, wherein at least one of a distance between the first ground engaging tool and the first finishing tool and a distance between the second ground engaging tool and the second finishing tool is a distance of from one foot to three feet.

17. The method of claim 13, wherein an angle of the disc blades of at least one of the first ground engaging tool and the second ground engaging tool is adjustable with respect to a direction of travel.

18. The farm implement of claim 1, wherein the at least one first finishing tool is adapted to carry substantially all of the residual weight of the farm implement not carried by the at least one ground engaging tool and a tow hitch connected to a towing equipment.

19. The method of claim 13, wherein the at least one first finishing tool is adapted to carry substantially all of the residual weight of the farm implement not carried by the at least one ground engaging tool and a tow hitch connected to a towing equipment, wherein in operation substantially no weight of the farm implement is carried by any wheels or tires of the farm implement.
